(19) United States
(12) Patent Application Publication
(10) Pub. No.: US 2018/0276193 A1
(43) Pub. Date: Sep. 27, 2018

(54) AUTOMATED LAYOUT FORMATTING OF DIGITAL INK USING CONTEXT

(71) Applicant: Microsoft Technology Licensing, LLC, Redmond, WA (US)

(72) Inventors: Christian Klein, Duvall, WA (US); Gregg R. Wygonik, Duvall, WA (US); Brandon Littell, Seattle, WA (US); Jan-Kristian Markiewicz, Redmond, WA (US); Jathusan Thiruchelvanathan, Redmond, WA (US)

(73) Assignee: Microsoft Technology Licensing, LLC, Redmond, WA (US)

(21) Appl. No.: 15/464,622

(22) Filed: Mar. 21, 2017

(51) Int. Cl. G06F 17/24; G06F 17/21

(52) U.S. Cl. CPC G06F 17/242; G06F 17/212; G06F 17/211

(57) ABSTRACT

An example system for formatting digital ink includes a processor configured to receive digital ink. The processor is to also detect a context in which the digital ink is received. Additionally, the processor is to detect a layout object in the digital ink. The processor is to further automatically format the layout object based on the detected context in response to detecting a break event.

### BACKGROUND

Mobile devices such as tablets and laptops may accept input from digital stylus pens or fingers in the form of digital ink. For example, a user may input digital ink using a digital stylus pen or finger by moving the nib or tip of the digital stylus pen or finger across the surface of the mobile device.

In some examples, input from a digital stylus pen may include strokes, pressure values associated with the strokes, and an angle of writing. In some examples, digital stylus pens may also include one or more buttons to provide additional input.

### SUMMARY

The following presents a simplified summary in order to provide a basic understanding of some aspects described herein. This summary is not an extensive overview of the claimed subject matter. This summary is not intended to identify key or critical elements of the claimed subject matter nor delineate the scope of the claimed subject matter. This summary's sole purpose is to present some concepts of the claimed subject matter in a simplified form as a prelude to the more detailed description that is presented later.

An embodiment described herein includes a system for formatting digital ink. The system includes memory and a processor configured to receive digital ink. The processor can also be configured to detect a context in which the digital ink is received. The processor can also detect a layout object in the digital ink. The processor can also be configured to automatically format the layout object based on the detected context in response to detecting a break event.

In another embodiment described herein, a method for formatting digital ink includes receiving, via a processor, digital ink. The method also includes detecting, via the processor, a context in which the digital ink is received. Additionally, the method includes detecting, via the processor, a layout object in the digital ink. The method further includes detecting, via the processor, a break event. The method also further includes automatically formatting, via the processor, the layout object based on the detected context in response to detecting the break event.

Another implementation provides one or more computer-readable storage devices for storing computer readable instructions that, when executed by one or more processing devices, instruct the automated formatting of digital ink. The computer-readable storage devices include instructions to receive digital ink. The computer-readable storage devices also include instructions to detect a context in which the digital ink is received. The computer-readable storage devices also include instructions to detect a layout object in the digital ink. The computer-readable storage devices also include instructions to detect a break event comprising a save event, a share event, a timer event, or a task change event. The computer-readable storage devices also further include instructions to automatically format the layout object based on the detected context in response to detecting the break event.

The following description and the annexed drawings set forth in detail certain illustrative aspects of the claimed subject matter. These aspects are indicative, however, of a few of the various ways in which the principles of the innovation may be employed and the claimed subject matter is intended to include all such aspects and their equivalents. Other advantages and novel features of the claimed subject matter will become apparent from the following detailed description of the innovation when considered in conjunction with the drawings.

### BRIEF DESCRIPTION OF THE DRAWINGS

The following detailed description may be better understood by referencing the accompanying drawings, which contain specific examples of numerous features of the disclosed subject matter.

FIG. 1 is a block diagram of an example of a computing system that can automatically format layout of digital ink using context;

FIG. 2 is a process flow diagram of another example method for automatically formatting layout of digital ink using context;

FIG. 3 is a process flow diagram of an example method for formatting layout based on feedback; and

FIG. 4 is a block diagram of an example computer-readable storage media that can automatically format layout of digital ink using context.

### DETAILED DESCRIPTION

As described above, a user may input digital ink using a digital stylus pen by moving the nib of an inking instrument such as a digital stylus pen across the surface of the mobile device. Alternatively, or in addition, digital ink may also be entered by moving a finger across the surface of the mobile device. In some instances, users may input data into a mobile device that may have traditionally been input using a keyboard or a mouse. However, due to various reasons, the digital ink input may not appear to be of the same aesthetic quality as traditional computer input tools, such as keyboards or mice. For example, writing may be spaced unevenly and of different size. Moreover, shapes may have been drawn asymmetrically. In addition, traditional menus and tools used with mice and keyboards may use a significant amount of display space and not be as easy to use with a digital stylus pen or a finger.

In embodiments described herein, a system can automatically format a layout of digital ink using context. As used herein, context may include any information about the environment in which digital ink is received from a user, including attributes of the physical environment and software environment, as well as attributes of the user. For example, attributes of the user may include identity, preferences, and behavior history of the user. In some examples, attributes of the physical environment may include time of day, physical location, proximity of other devices. In some examples, attributes of the software environment may include operating system, application receiving the ink, other running applications, and any active media playback. For example, the system can receive digital ink. The system can then detect a context in which the digital ink is received. In some examples, the context may include attribute of a physical environment or software environment in which the digital ink is received, or an attribute of the user. For example, the context can include a scheduled meeting, content of an application concurrently executed with the received digital ink, and subject matter of a digital notebook application to receive the digital ink, among other contexts. The system can detect a layout object in the digital ink. The system can also automatically format the layout object based on the detected context in response to detecting a break event. For example, the break event may include a save event, a print event, a share event, a timer event, a task change event, or a task completion event.

In some embodiments, the system described herein can also receive feedback indicating a mistake in formatting. For example, the feedback may be provided by a user. The system may then format the layout based on the feedback. The system can then store the feedback to use for detecting the context or for increasingly tailoring the formatting for a given layout to one or more detected preferences. For example, the detected preferences may be one or more preferences of a user. Thus, the present techniques enable an improved layout of digital ink that is consistent with a user's intent by using context. In some examples, the formatted digital ink may appear similar to digital ink that would have been produced if the user had taken more time to input the digital ink. Thus, the techniques described herein enable digital ink to be input more efficiently with the same output results. In addition, the formatted layout may be more legible and consistent than the input digital ink.

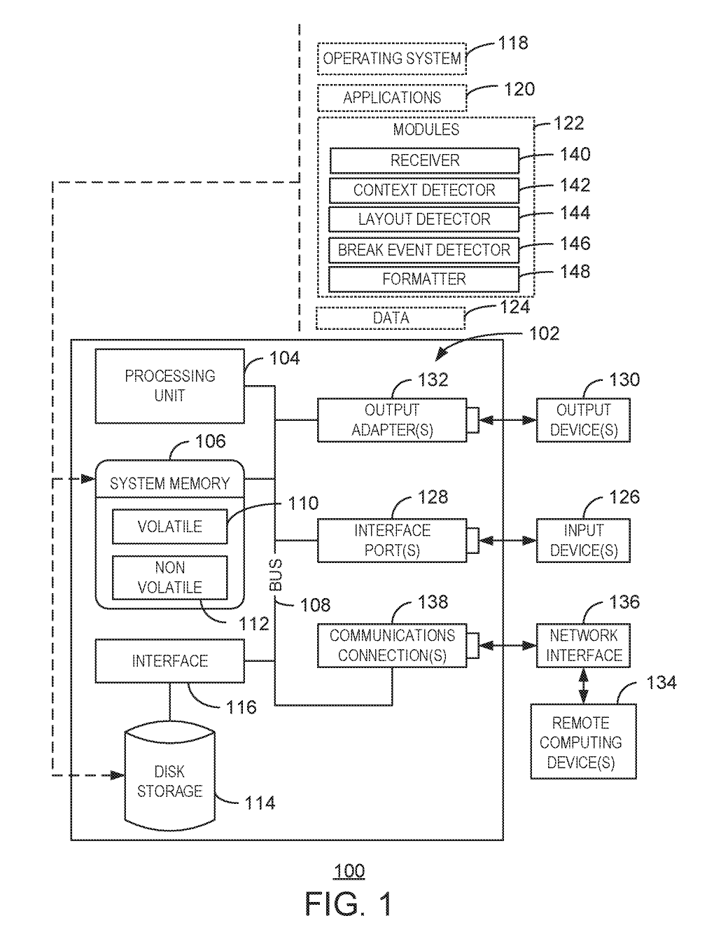

As a preliminary matter, some of the figures describe concepts in the context of one or more structural components, referred to as functionalities, modules, features, elements, etc. The various components shown in the figures can be implemented in any manner, for example, by software, hardware (e.g., discrete logic components, etc.), firmware, and so on, or any combination of these implementations. In one embodiment, the various components may reflect the use of corresponding components in an actual implementation. In other embodiments, any single component illustrated in the figures may be implemented by a number of actual components. The depiction of any two or more separate components in the figures may reflect different functions performed by a single actual component. FIG. 1 discussed below, provides details regarding different systems that may be used to implement the functions shown in the figures.

Other figures describe the concepts in flowchart form. In this form, certain operations are described as constituting distinct blocks performed in a certain order. Such implementations are exemplary and non-limiting. Certain blocks described herein can be grouped together and performed in a single operation, certain blocks can be broken apart into plural component blocks, and certain blocks can be performed in an order that differs from that which is illustrated herein, including a parallel manner of performing the blocks. The blocks shown in the flowcharts can be implemented by software, hardware, firmware, and the like, or any combination of these implementations. As used herein, hardware may include computer systems, discrete logic components, such as application specific integrated circuits (ASICs), and the like, as well as any combinations thereof.

As for terminology, the phrase “configured to” encompasses any way that any kind of structural component can be constructed to perform an identified operation. The structural component can be configured to perform an operation using software, hardware, firmware and the like, or any combinations thereof. For example, the phrase “configured to” can refer to a logic circuit structure of a hardware element that is to implement the associated functionality. The phrase “configured to” can also refer to a logic circuit structure of a hardware element that is to implement the coding design of associated functionality of firmware or software. The term “module” refers to a structural element that can be implemented using any suitable hardware (e.g., a processor, among others), software (e.g., an application, among others), firmware, or any combination of hardware, software, and firmware.

The term “logic” encompasses any functionality for performing a task. For instance, each operation illustrated in the flowcharts corresponds to logic for performing that operation. An operation can be performed using software, hardware, firmware, etc., or any combinations thereof.

As utilized herein, terms “component,” “system,” “client” and the like are intended to refer to a computer-related entity, either hardware, software (e.g., in execution), and/or firmware, or a combination thereof. For example, a component can be a process running on a processor, an object, an executable, a program, a function, a library, a subroutine, and/or a computer or a combination of software and hardware. By way of illustration, both an application running on a server and the server can be a component. One or more components can reside within a process and a component can be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any tangible, computer-readable device, or media.

Computer-readable storage media can include but are not limited to magnetic storage devices (e.g., hard disk, floppy disk, and magnetic strips, among others), optical disks (e.g., compact disk (CD), and digital versatile disk (DVD), among others), smart cards, and flash memory devices (e.g., card, stick, and key drive, among others). In contrast, computer-readable media generally (i.e., not storage media) may additionally include communication media such as transmission media for wireless signals and the like.

FIG. 1 is a block diagram of an example of a computing system that can automatically format layout of digital ink using context. The example system 100 includes a computing device 102. The computing device 102 includes a processing unit 104, a system memory 106, and a system bus 108. In some examples, the computing device 102 can be a gaming console, a personal computer (PC), an accessory console, a gaming controller, among other computing devices. In some examples, the computing device 102 can be a node in a cloud network.

The system bus 108 couples system components including, but not limited to, the system memory 106 to the processing unit 104. The processing unit 104 can be any of various available processors. Dual microprocessors and other multiprocessor architectures also can be employed as the processing unit 104.

The system bus 108 can be any of several types of bus structure, including the memory bus or memory controller, a peripheral bus or external bus, and a local bus using any variety of available bus architectures known to those of ordinary skill in the art. The system memory 106 includes computer-readable storage media that includes volatile memory 110 and nonvolatile memory 112.

The basic input/output system (BIOS), containing the basic routines to transfer information between elements within the computer 102, such as during start-up, is stored in nonvolatile memory 112. By way of illustration, and not limitation, nonvolatile memory 112 can include read-only memory (ROM), programmable ROM (PROM), electrically programmable ROM (EPROM), electrically erasable programmable ROM (EEPROM), or flash memory.

Volatile memory 110 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), SynchLink™ DRAM (SLDRAM), Rambus® direct RAM (RDRAM), direct Rambus® dynamic RAM (DRDRAM), and Rambus® dynamic RAM (RDRAM).

The computer 102 also includes other computer-readable media, such as removable/non-removable, volatile/non-volatile computer storage media. FIG. 1 shows, for example a disk storage 114. Disk storage 114 includes, but is not limited to, devices like a magnetic disk drive, floppy disk drive, tape drive, Jaz drive, Zip drive, LS-210 drive, flash memory card, or memory stick.

In addition, disk storage 114 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 114 to the system bus 108, a removable or non-removable interface is typically used such as interface 116.

It is to be appreciated that FIG. 1 describes software that acts as an intermediary between users and the basic computer resources described in the suitable operating environment 100. Such software includes an operating system 118. Operating system 118, which can be stored on disk storage 114, acts to control and allocate resources of the computer 102.

System applications 120 take advantage of the management of resources by operating system 118 through program modules 122 and program data 124 stored either in system memory 106 or on disk storage 114. It is to be appreciated that the disclosed subject matter can be implemented with various operating systems or combinations of operating systems.

A user enters commands or information into the computer 102 through input devices 126. Input devices 126 include, but are not limited to, a pointing device, such as, a mouse, trackball, stylus, and the like, a keyboard, a microphone, a joystick, a satellite dish, a scanner, a TV tuner card, a digital camera, a digital video camera, a web camera, and the like. In some examples, an input device can include Natural User Interface (NUI) devices. NUI refers to any interface technology that enables a user to interact with a device in a “natural” manner, free from artificial constraints imposed by input devices such as mice, keyboards, remote controls, and the like. In some examples, NUI devices include devices relying on speech recognition, touch and stylus recognition, gesture recognition both on screen and adjacent to the screen, air gestures, head and eye tracking, voice and speech, vision, touch, gestures, and machine intelligence. For example, NUI devices can include touch sensitive displays, voice and speech recognition, intention and goal understanding, and motion gesture detection using depth cameras such as stereoscopic camera systems, infrared camera systems, RGB camera systems and combinations of these. NUI devices can also include motion gesture detection using accelerometers or gyroscopes, facial recognition, three-dimensional (3D) displays, head, eye, and gaze tracking, immersive augmented reality and virtual reality systems, all of which provide a more natural interface. NUI devices can also include technologies for sensing brain activity using electric field sensing electrodes. For example, a NUI device may use Electroencephalography (EEG) and related methods to detect electrical activity of the brain. The input devices 126 connect to the processing unit 104 through the system bus 108 via interface ports 128. Interface ports 128 include, for example, a serial port, a parallel port, a game port, and a universal serial bus (USB).

Output devices 130 use some of the same type of ports as input devices 126. Thus, for example, a USB port may be used to provide input to the computer 102 and to output information from computer 102 to an output device 130.

Output adapter 132 is provided to illustrate that there are some output devices 130 like monitors, speakers, and printers, among other output devices 130, which are accessible via adapters. The output adapters 132 include, by way of illustration and not limitation, video and sound cards that provide a means of connection between the output device 130 and the system bus 108. It can be noted that other devices and systems of devices provide both input and output capabilities such as remote computing devices 134.

The computer 102 can be a server hosting various software applications in a networked environment using logical connections to one or more remote computers, such as remote computing devices 134. The remote computing devices 134 may be client systems configured with web browsers, PC applications, mobile phone applications, and the like. The remote computing devices 134 can be a personal computer, a server, a router, a network PC, a workstation, a microprocessor based appliance, a mobile phone, a peer device or other common network node and the like, and typically includes many or all of the elements described relative to the computer 102.

Remote computing devices 134 can be logically connected to the computer 102 through a network interface 136 and then connected via a communication connection 138, which may be wireless. Network interface 136 encompasses wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection 138 refers to the hardware/software employed to connect the network interface 136 to the bus 108. While communication connection 138 is shown for illustrative clarity inside computer 102, it can also be external to the computer 102. The hardware/software for connection to the network interface 136 may include, for exemplary purposes, internal and external technologies such as, mobile phone switches, modems including regular telephone grade modems, cable modems and DSL modems, ISDN adapters, and Ethernet cards.

The computer 102 includes one or more modules 122, such as a receiver module 140, a context detector module 142, a layout detector module 144, break event detector module 146, and a formatter module 148. In some embodiments, the receiver module 140 can receive digital ink. In some examples, the context detector module 142 can detect a context in which the digital ink is received. For example, the context may include a scheduled meeting. In some examples, the context may be an application concurrently executed with the received digital ink. In some examples, the context may be subject matter of a digital notebook application to receive the digital ink. For example, the subject matter of the digital notebook may be inferred by analyzing previously entered digital ink within the notebook.

The layout detector module 144 can detect a layout object in the digital ink. For example, the layout may be detected based on a layout pattern that is detected independent of content of the digital ink. As used herein, content refers to the meaning, values, or subject matter conveyed by the digital ink. For example, the content may include a subject matter of detected text in the digital ink. In some examples, the layout object may include a list, a table, a paragraph, or a chart, among other possible layout objects. In some examples, the layout detector module 144 can also reference a non-text example for analysis of both the content and the layout. For example, a non-text example may be used for meaning of a “circle” shape in a diagram. In some examples, a non-text example may also be used for the shape's layout. For example, layout detector module 144 can used the non-text example to determine the shape's position on the page, spatial relationship to other shapes in the diagram, etc.

The break event detector module 146 can detect a break event. The break event may signal an appropriate time for automatically formatting the layout of the digital ink. For example, the break event may be a save event, a print event, a share event, a timer event, a task change event, or a task completion event, among other possible break events. The formatter module 148 can automatically format the layout object based on the detected context in response to detecting a break event. For example, the layout may be formatted and displayed to the user. In some examples, the user may then provide feedback as to the accuracy of the formatting. More specifically, the feedback may indicate the accuracy of the automatic formatting of the original format of the input digital ink. For example, the feedback may be used to format the layout and be stored in disk storage 114 to be used to detect context in future automated formatting. In some examples, the user feedback may also be used to improve the accuracy of automatic reformatting of similar layouts in the future. For example, a particular user may prefer layouts of lists or tables to appear a certain way. In some examples, the formatter module 148 can learn these preferences of the user over time through the user's feedback on earlier attempts at generically formatting such layouts.

It is to be understood that the block diagram of FIG. 1 is not intended to indicate that the computing system 102 is to include all of the components shown in FIG. 1. Rather, the computing system 102 can include fewer or additional components not illustrated in FIG. 1 (e.g., additional applications, additional modules, additional memory devices, additional network interfaces, etc.). Furthermore, any of the functionalities of the receiver module 140, the context detector module 142, the layout detector module 144, the break event detector module 146, or the formatter module 148, the may be partially, or entirely, implemented in hardware and/or in the processor 104. For example, the functionality may be implemented with an application specific integrated circuit, in logic implemented in the processor 104, or in any other device.

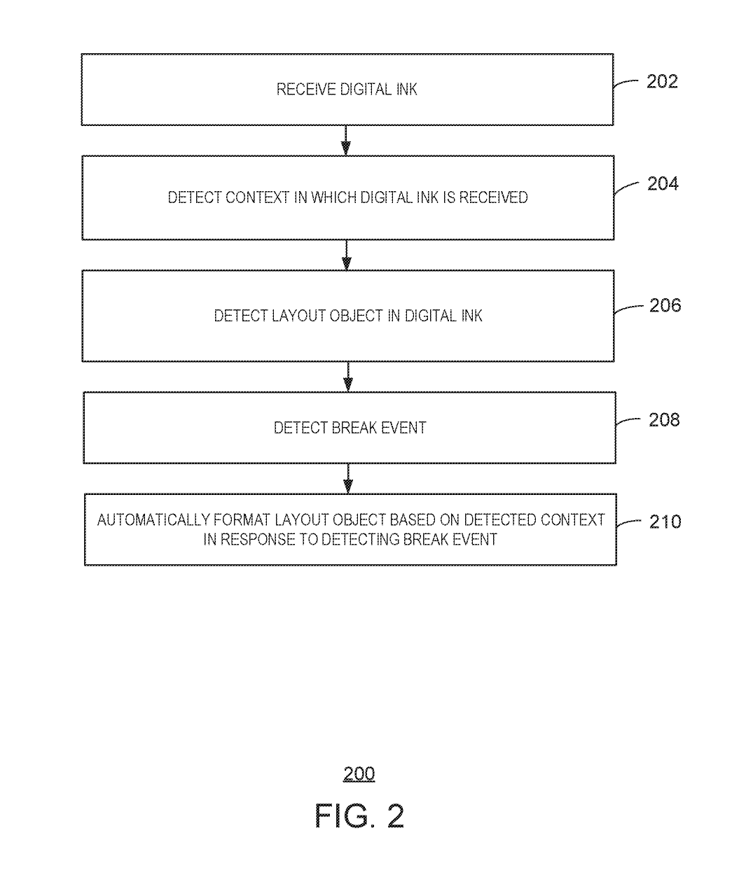

FIG. 2 is a process flow diagram illustrating an example method for automatically formatting layout of digital ink using context. The method 200 can be implemented with any suitable computing device, such as the computing system 102 of FIG. 1.

At block 202, a processor receives digital ink. For example, the digital ink may be received via a digital stylus pen or a finger at a display surface. In some examples, the digital ink may include handwriting, shapes, tables, and lists, among other digital ink input.

At block 204, the processor detects a context in which the digital ink is received. For example, the context may be a scheduled meeting. In some examples, if the processor detects a scheduled meeting based on calendar information, then that information can be used to detect context for digital ink being received. For example, as a user writes a note, the note may be related to a conversation that the user is engaged in. In some examples, the processor may use the context of the note to establish a likely layout intended by the user. For example, notes written in the context of the scheduled meeting may be more likely to be a list of action items. In some examples, the list of action items may use a layout that is typically formatted a certain way that is distinct from a generic list, or generic notes. In some examples, the detected context of a meeting may be a topic that the meeting is about, the description of the meeting or the other people that are invited into the meeting.

In some examples, the processor may detect the context based on analysis of the actual content of the digital ink. For example, the processor can detect the actual words that a user is writing and, by extension, the subject matter described by the words. Thus, the processor can convert the digital ink into text and then process the text in order to detect a subject matter of a task or a document. The detected subject matter can be used to detect a context of the digital ink and thereby predict relevant details concerning the user's intended layout. For example, if the written words reveal that the content is a note written to a loved one versus a work communication, then the system can leverage that as context to better adapt a note's layout. In another example, the note to the loved one may retain more imperfections while the work communication may be formatted to be more clean, legible and consistent. For example, the imperfections may be considered “personal touches” that better communicate emotion.

In some examples, the processor may detect context based on an application being used to input the digital ink. For example, a user may be writing a note in a digital notebook application that is to receive the digital ink. In some examples, a digital notebook in the digital notebook application may have a particular subject. For example, the entire digital notebook may have a heading, or the user may be authoring a particular section of the digital notebook having a particular heading or subject matter. Such information may provide useful context that the processor may use to infer the intended purpose of the digital ink as described below.

In some examples, the processor may detect the context based on a selection of personal preferences. For example, the context may be based on a user's selection of one or more personal preferences. In one example, the context may be detected based on a selection of a pen tool. The processor may receive a selection from a user as to a pen tool that a digital stylus pen or finger may correspond to. For example, the pen tool may be a pencil, a marker, or a highlighter. In some examples, the pen tool may be a more specialized tool, such as a calligraphy brush or a red pen that may be used for annotations and corrections. The user may thus be providing information to the system about what they plan to do with the digital stylus pen or finger by virtue of which pen tool is selected and which settings are selected. For example, the settings may be a color assigned to the pen and a brush width, and the like. The processor may thus detect a context based on the selection of pen tool and settings accordingly.

In some examples, the context may be detected based on historical context of the user or context created by other users. For example, a context may be detected based on a user's past behavior. In some examples, other users may be co-authors, reviewers, or readers of the content. Thus, a larger data set may be stored and used for context detection. For example, the processor may detect and learn that a user tends to create flow charts in a certain way. Flow charts may have certain rules in how their layouts tend to work. For example, flow charts may assign meaning to certain shapes like circles and arrows. Flow charts may thus also map to a particular kind of intent. Thus, the processor may detect that a user is drawing a flow chart and clean up the layout of the flow chart according to the rules of flow charts. In some examples, the user may use arrows, or may use lines, or may prefer to use circles or squares for the different items in a flow chart. Such recorded past behavior that may differ in some cases from general rules can be used by the processor to detect context for the automated formatting later on. In one example, a device may receive digital ink in the form of an ambiguously drawn shape. For example, the squiggly shape could be more of an oval or it could be a rectangle. In some examples, the processor can disambiguate the shape based on past behavior of a user, as the user may tend to prefer or create flow charts with rectangles. Thus, the processor may detect a context of flow chart preparation based on this historical context.

In some examples, the context may be detected based on a detected layout pattern. For example, the processor can detect a layout pattern by comparing the received digital ink to previously received digital ink. In some examples, the processor may also detect a layout pattern based on feedback as described below.

In some examples, the process can detect context based on a proximity of one or more other devices. For example, one or more other people may have been invited into a meeting that a user is attending. In some examples, the device can detect that other people are nearby and that those people could be in the same room based on proximity of other devices. For example, those may be people that a user may be actively collaborating with. In some examples, a document that the user is currently writing may have more than one author, and different people may be authoring the document at the same time. Thus, the processor may use all of this information to detect the context of what type of document the user is currently producing.

In some examples, the processor can detect a context based on a concurrently executed application. For example, in addition to an application such as a word processor or note taking application, the processor may detect another application is running concurrently with the receiving of the digital ink. In some examples, the concurrent application may be a web browser. Thus, in one example, a user may be inputting notes that are contextual to something that is displayed in another application. For example, the user may be planning a family vacation, and may have a browser window open. The browser may have one or more websites displayed, such as flight information or hotels. At the same time, the user may be taking notes in a separate window. Those notes may thus be contextual to the web pages being viewed in a user's web browser. Therefore, the processor may detect a context based on one or more detected websites or content being displayed in the websites when a user is inputting a note using a digital stylus pen or a finger.

At block 206, the processor detects a layout object in the digital ink. For example, the layout object may be detected based on a layout pattern that is detected independent of content of the digital ink. For instance, the processor can detect that a user is writing text, and further detects that the writing is in a paragraph versus in a list. In some examples, the processor can also detect an angle that words and sentences are written in. In some examples, the layout pattern may be a type of grid. For example, the grid may correspond to a table. In some examples, the processor may accordingly detect that the content is intended to be in a two-dimensional table with rows and columns. Moreover, the processor may not necessarily need to detect the grid lines in order to detect an intended table. Rather, the processor may detect implied grid lines through a stated layout. Thus, the processor can detect implied grid lines and format the table accordingly. In some examples, the processor may even add grid lines that the user didn't include originally. In some examples, the processor can change the appearance of grid lines to make top level lines bolder and other grid lines a lighter weight based on the nature of the table that the user is making.

At block 208, the processor detects a break event. For example, the break event may include a save event, a print event, a share event, a timer event, a task change event, or a task completion event. In some examples, a save event may correspond to a user saving a digital ink document. For example, a user may save a digital ink document after inputting the digital ink. In some examples, a save event may have been generated because a user explicitly executed a save command. In other example, the save event may correspond to an automatic saving behavior that exists based on inactivity, or based on putting the device away, or switching to another piece of content, or any other auto save feature.

In some examples, a print event may correspond to a user printing a digital ink document. For example, the processor may detect a print job related to the digital ink document. In some examples, the share event may correspond to a user sharing a digital ink document with others. For example, the processor may detect that a digital ink document is being attached to an email or otherwise being transmitted. The processor may thus enable a user to send a version of digital ink that may be a better reflection of the work the user performed.

In some examples, a timer event may correspond to a preset interval for performing digital ink formatting. For example, the user may configure a timer to have digital ink automatically formatted at the configured interval. In some examples, the timer event may correspond to an inactivity timer. For example, the digital ink may be formatted in response to detecting a predetermined period of inactivity.

In some examples, the task change event may correspond to a detected task change. For example, the processor may detect that a user has stopped inputting digital ink and is performing another task, such as browsing the Internet via a browser or watching a video, etc. In some examples, the task change event may be detected based on an active window changing from a digital ink input application window to another window. In some examples, the task change event may be detected in the case of a journal or a notebook. For example, the journal or notebook might be divided up into sections or it might be divided up into pages. The processor may perform the formatting whenever the user switches between sections or pages. In some examples, a completion event may be detected based on the content of a digital ink. For example, the processor may determine that the user is finished working on a task based on the content of the digital ink. As one example, a user may be drawing a flow chart. The user may finish drawing the flow chart and then begin writing a note on the same page. In some examples, although the note may be on the same page, in some examples below the flow chart, the processor can detect that the flow chart is a completed task. In response to detecting that the flow chart is a completed task, to the processor can format the flow chart according to techniques described herein. Thus, the above break events generally have the advantage that they are less likely to be disruptive by not interrupting the user while the user is inputting additional related digital ink.

At block 210, the processor automatically formats the layout object based on the detected context in response to detecting the break event. For example, the processor can detect an intended layout pattern based on the detected context. In some examples, formatting the layout may be based on the detected intended layout pattern. In some examples, the processor may have detected a paragraph with justified text, center aligned text, or right aligned text as the layout object. For example, a user may be writing in the middle of a page or in the middle of a blank canvass on a device and the text might drift and end up not being totally aligned. In some examples, the processor can format one or more sentences of the paragraph with a consistent alignment. In some examples, the processor may have detected a paragraph with an intended left alignment of lines, and transform the detected lines to be left aligned. In another example, the processor may have detected smaller writing or reduced space between words at the end of a line in a paragraph and formatted the paragraph by wrapping the smaller writing or words at the end of the line to a subsequent line in the paragraph. Similarly, where a user may have written the next word on the following line even though the word would fit on the previous line, the processor may detect such a situation and rearrange the contents so that the paragraph appears in a neater and more uniform format. In some examples, the processor may also automatically add hyphenation when appropriate to improve the appearance of paragraphs. In some example, the processor may not necessarily replace the user's handwriting with typed text in order to perform the formatting. For example, the processor can move the handwritten text directly or generate new ink in the same style as the original handwriting.

In yet another example, the processor may have detected digital ink content as being a list and left-align list items, while preserving any intentional indentations. In some examples, the processor may left align the appropriate levels of the detected list and then appropriately indent some items that the processor may detect that the user's intent was to actually have indented at a different level of the hierarchy of the list. The processor may also replace the list markers with cleaned up and consistent list markers. For example, the markers may be bullet points or hyphens. In some examples, the processor may replace the list markers with similar list markers rather than identical markers to maintain the semi-random appearance of handwriting.

In another example, the processor may detect flowcharts or other non-text ink layout patterns, and format them towards the recognized patterns. For example, the processor may snap a flowchart to an invisible layout grid. In another example, the processor may snap elements of a diagram into an invisible layout grid, so that afterwards, elements of the diagram appear aesthetically pleasing. For example, all of the shapes in the diagram may line up and the arrows in the diagram may point in straight directions. In some examples, the processor may have detected an angle that words or sentences are written and transform them to be horizontal. For example, if a user is not writing on lined paper, then the user's text may have a tendency of drifting. Thus, the user's writing may be at a diagonal, or the user's written text may be curved. In some examples, the processor can detect the layout pattern that the text should be in a straight line, and automatically straighten the line so that the text is consistently lined up as if the user had been writing on lined paper. Otherwise, if the processor detects that strongly curved texts or curved lines are part of a diagram or for artistic effect, then the processor may not format such texts or lines to be in a straight line.

In some examples, the processor may use the detected context to normalize content that a user is creating not just within a current session but also across sessions. For example, the detected past behavior of a user may be used to normalize content across time. In some examples, normalizing content may include normalizing the size of the text or the weight of the digital ink. Thus, as the user is writing and provides digital ink closer to the bottom of a page, the user may be naturally inclined to write smaller so that the user does not run out of room. In some examples, the processor may detect that the user is not deliberately writing in a different size. Thus, the processor may normalize the size so that all the text on the pages is of a consistent size. Ink weight may be detected by a pressure exerted by the user on the screen with the pen. In some examples, the processor may detect that the content that's being authored is inconsistent or sloppy with regard to ink weight. For example, the user may have initially applied more pressure when providing digital ink input, but the pressure corresponding to the digital ink input may decrease over time. Thus, the digital ink strokes may show an initial bold set of strokes and ended with thinner strokes. In some examples, if the processor detects that the user's intent was to have consistent ink weight based on detected context, then the process may normalize the ink weight accordingly.

In one embodiment, the process flow diagram of FIG. 2 is intended to indicate that the steps of the method 200 are to be executed in a particular order. Alternatively, in other embodiments, the steps of the method 200 can be executed in any suitable order and any suitable number of the steps of the method 200 can be included. Further, any number of additional steps may be included within the method 200, depending on the specific application.

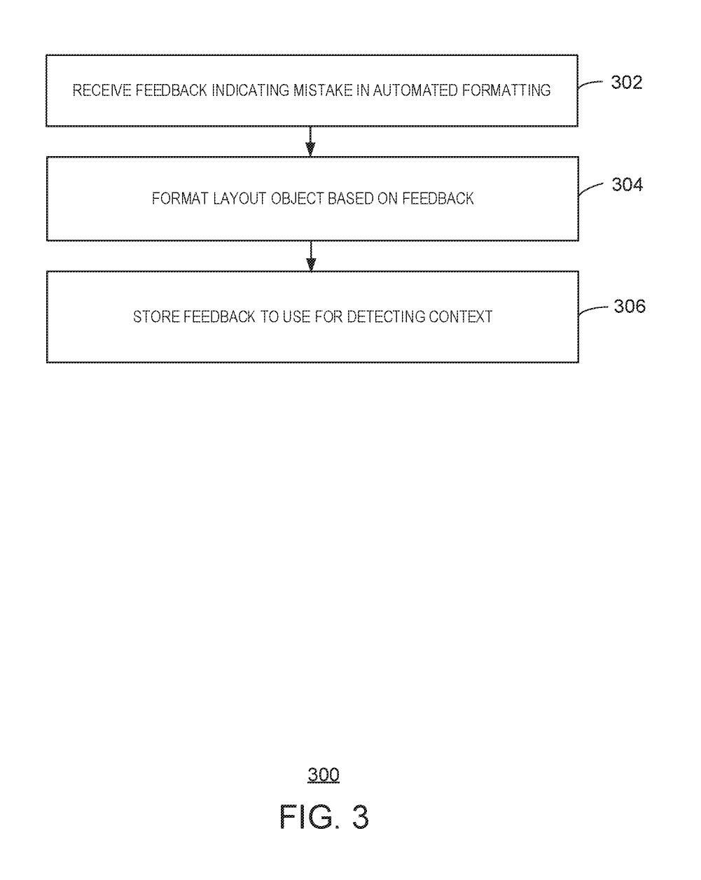

FIG. 3 is a process flow diagram illustrating an example method for formatting layout based on feedback. The method 300 can be implemented with any suitable computing device, such as the computing system 102 of FIG. 1.

At block 302, the processor receives feedback indicating a mistake in automated formatting. For example, the feedback may be received after the digital ink layout has been automatically formatted using the method 200 above. In some examples, the feedback may be from a user. For example, the processor may receive a setting via user controls in a user interface that allow a user to tweak a behavior. For example, the settings may enable switching between formatting in a more aggressive or a more conservative manner. In some examples, the user may not want any formatting to be applied to a particular digital ink. For example, the user may be engaged in an artistic drawing. Thus, for example, even though circles that a user may be drawing result in ovals, the user may intend the circles to include points that are not aligned with the radius of the circle. Thus, the user may provide feedback that such ovals or imperfect circles are not to be formatted. In some examples, the feedback may be from a reviewer that may make a correction to the user's content later. In some examples, the feedback may originate from an intelligent agent examining content produced by a plurality of users.

At block 304, the processor formats the layout based on the feedback. For example, the processor may format a circle as a freeform drawing rather than a pie chart in response to receiving the feedback. In some examples, the user may manipulate a UI widget like a slider to change the strength of layout change from aggressive to conservative. The layout may be formatted according to a more conservative strength accordingly. In some examples, the user may have selected a particular layout, region, object, context, and then applied a strength of layout change to the selection. In some examples, the user may proactively have specified a desired behavior. For example, the user may have turned the layout formatting system off, or specified a layout they are about to employ. The processor may remove formatting or format per the specified layout accordingly. In some examples, the user may have selected a layout that has been formatted by the system and then corrected the layout type. The processor may show previews of possible alternate formats for the user to select from. In some examples, the user may have identified specific aspects of their original input digital ink which they would like to improve or retain as-is. For example, the specific identified aspects may include a size, an orientation, a weight, etc. In some examples, the user may have provided feedback implicitly by adding relevant context after the fact. For example, the user may have written more text which clarifies the meaning of the document. The processor may thus change its original assessment according to the clarified meaning and modify the format of the layout accordingly. In some examples, the system may have proactively prompted the user for clarification concerning a desired layout or other relevant details. For example, the processor may have prompted for the clarification in response to detecting a low confidence in disambiguating between alternatives.

At block 306, the processor stores the feedback to use for detecting the context. For example, feedback may be used by the processor to more accurately detect a context of additional received digital ink. The feedback may thus improve the likelihood that the system correctly infers the intended layout type. In some examples, the feedback may also be used to improve the ability of the processor to format a particular layout in the specific way the user prefers.

In one embodiment, the process flow diagram of FIG. 3 is intended to indicate that the steps of the method 300 are to be executed in a particular order. Alternatively, in other embodiments, the steps of the method 300 can be executed in any suitable order and any suitable number of the steps of the method 300 can be included. Further, any number of additional steps may be included within the method 300, depending on the specific application. For example, the processor may also additionally provide alternative formatted digital ink samples in response to receiving feedback from the user.

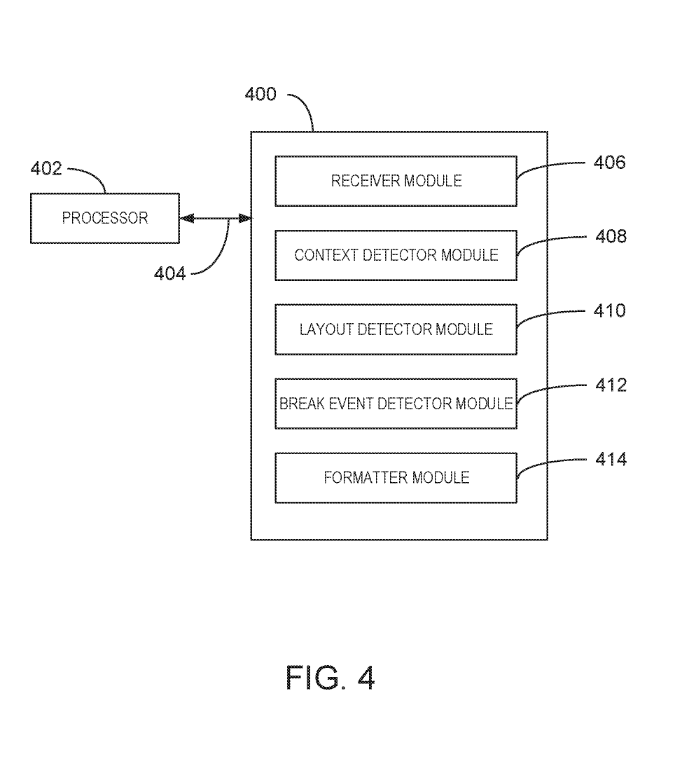

FIG. 4 is a block diagram of an example computer-readable storage media that can automatically format layout of digital ink using context. The tangible, computer-readable storage media 400 may be accessed by a processor 402 over a computer bus 404. Furthermore, the tangible, computer-readable storage media 400 may include code to direct the processor 402 to perform the steps of the current methods.

The various software components discussed herein may be stored on the tangible, computer-readable storage media 400, as indicated in FIG. 4. For example, the tangible computer-readable storage media 400 can include a receiver module 406, a context detector module 408, a layout detector module 410, a break event detector module 412, and a formatter module 414. In some embodiments, the receiver module 406 can receive digital ink. In some examples, the context detector module 408 can detect a context in which the digital ink is received. For example, the context may include a scheduled meeting, content of an application concurrently executed with the received digital ink, or subject matter of a digital notebook application that is to receive the digital ink.

The layout detector module 410 can detect a layout object in the digital ink. For example, the layout object may include a list, a table, a paragraph, or a chart. The break event detector module 412 can detect a break event. For example, the break event may include a save event, a print event, a share event, a timer event, a task change event, or a task completion event. The formatter module 414 can automatically format the layout object based on the detected context in response to detecting the break event. In some examples, the receiver module 406 can also receive feedback indicating a mistake in automated formatting. The formatter module 414 can then format the layout based on the feedback. In some examples, the receiver module 406 can also store the feedback to use for detecting the context. It is to be understood that any number of additional software components not shown in FIG. 4 may be included within the tangible, computer-readable storage media 400, depending on the specific application.

### EXAMPLE 1

This example provides for a system for formatting digital ink. The system includes a processor configured to receive digital ink. The processor may also be configured to detect a context in which the digital ink is received. The processor may further be configured to detect a layout object in the digital ink. The processor may further also be configured to automatically format the layout object based on the detected context in response to detecting a break event. Alternatively, or in addition, the context may include an attribute of a physical environment or software environment in which the digital ink is received, or an attribute of the user. Alternatively, or in addition, the context may include content in an application concurrently executed with the received digital ink. Alternatively, or in addition, the context may include a subject matter of a digital notebook application to receive the digital ink. Alternatively, or in addition, the layout object may be detected based on a layout pattern that is detected independent of content of the digital ink. The content may include a subject matter of detected text in the digital ink. Alternatively, or in addition, the layout object may include a list, a table, a paragraph, or a chart. Alternatively, or in addition, the break event may include a save event, a print event, a share event, a timer event, a task change event, or a task completion event.

### EXAMPLE 2

This example provides for a method for formatting digital ink. The method can include receiving, via a processor, digital ink. The method can also include detecting, via the processor, a context in which the digital ink is received. The method can also include detecting, via the processor, a layout object in the digital ink. The method can also include detecting, via the processor, a break event. The method can further include automatically formatting, via the processor, the layout object based on the detected context in response to detecting the break event. Alternatively, or in addition, the method may include detecting the context based on a selection of a personal preference. Alternatively, or in addition, the method may include detecting the context based on historical content of the user or content created by other users. Alternatively, or in addition, the method may include detecting an intended layout pattern based on the detected context. Formatting the layout object may be based on the detected intended layout pattern. Alternatively, or in addition, the method may include detecting the context based on a proximity of one or more other devices. Alternatively, or in addition, the method may include detecting the layout object based on a layout pattern that is detected independent of content of the digital ink. Alternatively, or in addition, the method may include detecting a layout pattern by comparing the received digital ink to previously received digital ink content. Alternatively, or in addition, the method may include receiving feedback indicating a mistake in automated formatting. Alternatively, or in addition, the method may include formatting the layout based on the feedback. Alternatively, or in addition, the method may include storing the feedback to use for detecting the context, and for increasingly tailoring the formatting for a given layout to one or more detected preferences.

### EXAMPLE 3

This example provides for one or more computer-readable storage medium for storing computer readable instructions that, when executed by one or more processing devices, instruct the automated formatting of digital ink. The computer-readable medium include instructions to receive digital ink. The computer-readable medium also include instructions to detect a context in which the digital ink is received. Further, the computer-readable medium include instructions to detect a layout object in the digital ink. The computer-readable medium include instructions to detect a break event. The computer-readable medium include instructions to automatically format the layout object based on the detected context in response to detecting the break event. Alternatively, or in addition, the computer-readable medium also include instructions to receive feedback indicating a mistake in automated formatting. Alternatively, or in addition, the computer-readable medium also include instructions to format the layout based on the feedback. Alternatively, or in addition, the computer-readable medium also include instructions to store the feedback to use for detecting the context, and for increasingly tailoring the formatting for a given layout to one or more detected preferences. Alternatively, or in addition, the context may include a scheduled meeting, content of an application concurrently executed with the received digital ink, or subject matter of a digital notebook application to receive the digital ink. Alternatively, or in addition, the layout object may include a list, a table, a paragraph, or a chart. Alternatively, or in addition, the break event may include a save event, a print event, a share event, a timer event, a task change event, or a task completion event.

### EXAMPLE 4

This example provides for a system for formatting digital ink. The system includes means for receiving digital ink. The system also include means for detecting a context in which the digital ink is received. The system further includes means for detecting a layout object in the digital ink. The system also further includes means for automatically formatting the layout object based on the detected context in response to detecting a break event. Alternatively, or in addition, the context may include an attribute of a physical environment or software environment in which the digital ink is received, or an attribute of the user. Alternatively, or in addition, the context may include content in an application concurrently executed with the received digital ink. Alternatively, or in addition, the context may include a subject matter of a digital notebook application to receive the digital ink. Alternatively, or in addition, the layout object may be detected based on a layout pattern that is detected independent of content of the digital ink. The content may include a subject matter of detected text in the digital ink. Alternatively, or in addition, the layout object may include a list, a table, a paragraph, or a chart. Alternatively, or in addition, the break event may include a save event, a print event, a share event, a timer event, a task change event, or a task completion event.

In particular and in regard to the various functions performed by the above described components, devices, circuits, systems and the like, the terms (including a reference to a “means”) used to describe such components are intended to correspond, unless otherwise indicated, to any component which performs the specified function of the described component, e.g., a functional equivalent, even though not structurally equivalent to the disclosed structure, which performs the function in the herein illustrated exemplary aspects of the claimed subject matter. In this regard, it will also be recognized that the innovation includes a system as well as a computer-readable storage media having computer-executable instructions for performing the acts and events of the various methods of the claimed subject matter.

There are multiple ways of implementing the claimed subject matter, e.g., an appropriate API, tool kit, driver code, operating system, control, standalone or downloadable software object, etc., which enables applications and services to use the techniques described herein. The claimed subject matter contemplates the use from the standpoint of an API (or other software object), as well as from a software or hardware object that operates according to the techniques set forth herein. Thus, various implementations of the claimed subject matter described herein may have aspects that are wholly in hardware, partly in hardware and partly in software, as well as in software.

The aforementioned systems have been described with respect to interaction between several components. It can be appreciated that such systems and components can include those components or specified sub-components, some of the specified components or sub-components, and additional components, and according to various permutations and combinations of the foregoing. Sub-components can also be implemented as components communicatively coupled to other components rather than included within parent components (hierarchical).

Additionally, it can be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In addition, while a particular feature of the claimed subject matter may have been disclosed with respect to one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

1. A system for formatting digital ink, the system comprising a processor configured to:
receive digital ink;
detect a context in which the digital ink is received;
detect a layout object in the digital ink;
detecting a break event comprising a save event, a print event, a share event, or a task change event; and
automatically format the layout object based on the detected context to generate and display a modified digital ink comprising the formatted layout object in response to detecting the break event.

2. The system of claim 1, wherein the context comprises an attribute of a physical environment or software environment in which the digital ink is received, or an attribute of the user.

3. The system of claim 1, wherein the context comprises content in an application concurrently executed with the received digital ink.

4. The system of claim 1, wherein the context comprises a subject matter of a digital notebook application to receive the digital ink.

5. The system of claim 1, wherein the layout object is detected based on a layout pattern that is detected independent of content of the digital ink, wherein the content comprises a subject matter of detected text in the digital ink.

6. The system of claim 1, wherein the layout object comprises a list, a table, a paragraph, or a chart.

7. (canceled)

8. A method for formatting digital ink, comprising:
receiving, via a processor, digital ink;
detecting, via the processor, a context in which the digital ink is received;
detecting, via the processor, a layout object in the digital ink;
detecting, via the processor, a break event comprising a save event, a print event, a share event, or a task change event; and
automatically formatting, via the processor, the layout object to generate and display a modified digital ink comprising the formatted layout object based on the detected context in response to detecting the break event.

9. The method of claim 8, further comprising detecting the context based on a selection of a personal preference.

10. The method of claim 8, further comprising detecting the context based on historical content of the user or content created by other users.

11. The method of claim 8, further comprising detecting an intended layout pattern based on the detected context, wherein formatting the layout object is based on the detected intended layout pattern.

12. The method of claim 8, further comprising detecting the context based on a proximity of one or more other devices.

13. The method of claim 8, further comprising detecting the layout object based on a layout pattern that is detected independent of content of the digital ink.

14. The method of claim 8, further comprising detecting a layout pattern by comparing the received digital ink to previously received digital ink content.

15. The method of claim 8, further comprising:
receiving feedback indicating a mistake in automated formatting;
formatting the layout based on the feedback;
storing the feedback; and
detecting the context and increasingly tailoring the formatting for a given layout to one or more detected preferences based on the stored feedback.

16. One or more computer-readable memory storage devices for storing computer-readable instructions that, when executed by one or more processing devices, automatically format digital ink, the computer-readable instructions comprising code to:
receive digital ink;
detect a context in which the digital ink is received;
detect a layout object in the digital ink;
detect a break event comprising a save event, a print event, a share event, or a task change event; and
automatically format the layout object to generate and display a modified digital ink comprising the formatted layout object based on the detected context in response to detecting the break event.

17. The one or more computer-readable memory storage devices of claim 16, the computer-readable instructions comprising code to:
receive feedback indicating a mistake in automated formatting;
format the layout based on the feedback;
store the feedback; and
detecting the context and increasingly tailoring the formatting for a given layout to one or more detected preferences based on the stored feedback.

18. The one or more computer-readable memory storage devices of claim 16, wherein the context comprises a scheduled meeting, content of an application concurrently executed with the received digital ink, or subject matter of a digital notebook application to receive the digital ink.

19. The one or more computer-readable memory storage devices of claim 16, wherein the layout object comprises a list, a table, a paragraph, or a chart.

20. (canceled)
